(19) United States
(12) Patent Application Publication
(10) Pub. No.: US 2026/0267697 A1
(43) Pub. Date: Sep. 10, 2026

(54) MACHINE LEARNING-BASED EVENT SCHEDULING FOR ENERGY OPTIMIZATION

(71) Applicant: Cisco Technology, Inc., San Jose, CA (US)

(72) Inventor: Niall L McDonnell, Galway (IE)

(21) Appl. No.: 19/071,645

(22) Filed: Mar. 5, 2025

(51) Int. Cl. G06F 9/50; G06N 3/092

(52) U.S. Cl. CPC G06F 9/5027; G06N 3/092

(57) ABSTRACT

Devices, systems, methods, and processes relate to reducing carbon footprint of running an application, such as a latency-sensitive real-time application, on a computing device without compromising responsiveness of the application. The computing device iteratively performs a reinforcement learning process over a time period for the application, where the application is associated with a plurality of events. The plurality of events comprises network events, operating system events, timer events, communication events, collaboration events, security events, or user input events. The computing device learns, based on the iteratively performed reinforcement learning process, an event scheduling ruleset for the application that defines whether to run an event of the plurality of events on a low-power thread or a standard-power thread, and schedules at least one event of the plurality of events based on the learned event scheduling ruleset. The low-power thread has lower energy consumption compared to the standard-power thread.

The present disclosure relates to computing systems. More particularly, the present disclosure relates to machine learning-based event scheduling on computing systems for energy optimization.

### BACKGROUND

The rapid expansion of internet connectivity over the past few decades has revolutionized the way people communicate, collaborate, and conduct business. Round the clock accessibility of high-speed internet has enabled the growth of digital platforms that facilitate remote communication and teamwork across the globe. One of the notable developments in this transformation has been the rise of various real-time collaboration platforms (e.g., latency-sensitive real time collaboration applications). Collaboration platforms for video conferencing, instant messaging, file sharing, project management, gaming, or the like have enabled individuals to interact seamlessly, regardless of their physical location.

However, as the use of collaboration platforms continues to surge, so does the environmental impact associated with it. The widespread use of these collaboration platforms requires substantial infrastructure, including data centers, cloud services, and user equipment. While these collaboration platforms bring numerous benefits, the energy consumption tied to these technologies, particularly in the form of user equipment, is often overlooked. Devices such as laptops, smartphones, and desktops, which are heavily utilized for virtual meetings or collaborative interactions, account for a significant portion of the overall carbon emissions in the digital ecosystem. As the demand for these collaboration platforms grows, so does the energy consumption. This creates a complex challenge to balance the operational benefits of collaboration platforms with the increasing environmental impact of the digital infrastructure that powers it.

### SUMMARY OF THE DISCLOSURE

Systems and methods for computing systems involving reinforcement learning-based event scheduling to improve resource allocation and reduce energy consumption in accordance with embodiments of the disclosure are described herein.

In an embodiment, a device includes a processor and a memory communicatively coupled to the processor. The memory comprises a sustainability logic that is configured to iteratively perform a reinforcement learning process over a time period for an application. The application is associated with a plurality of events. The sustainability logic is further configured to learn, based on the iteratively performed reinforcement learning process, an event scheduling ruleset for the application that defines whether to run an event of the plurality of events on a low-power thread or a standard-power thread, and schedule at least one event of the plurality of events based on the learned event scheduling ruleset.

In further embodiments, the reinforcement learning process includes receiving an event associated with the application. The event may be one of the plurality of events and the application may correspond to a latency-sensitive real-time collaboration application. The reinforcement learning process further includes performing an action based on the received event, the action including one of running the received event on the low-power thread or running the received event on the standard-power thread. The reinforcement learning process further includes obtaining, upon performing the action, one or more performance characteristics associated with at least one of the processor or the application, determining, based on the one or more performance characteristics, a reward of the performed action for the received event, and storing the received event, the performed action, and the determined reward in a decision database.

In more embodiments, the learning of the event scheduling ruleset is further based on the decision database.

In some more embodiments, based on the decision database specifying that running a first event of the plurality of events on the low-power thread has a higher reward than running the first event on the standard-power thread, a first rule in the event scheduling ruleset for the first event defines a higher preference to run the first event on the low-power thread compared to running the first event on the standard-power thread.

In yet more embodiments, based on the decision database specifying that running a second event of the plurality of events on the low-power thread has a lower reward than running the second event on the standard-power thread, a second rule in the event scheduling ruleset for the second event defines a higher preference to run the second event on the standard-power thread compared to running the second event on the low-power thread.

In still more embodiments, based on the decision database specifying that running a first event of the plurality of events on the low-power thread has a higher reward than running the first event on the standard-power thread, a first rule in the event scheduling ruleset for the first event defines the first event to be run on the low-power thread.

In still yet more embodiments, based on the decision database specifying that running a second event of the plurality of events on the low-power thread has a lower reward than running the second event on the standard-power thread, a second rule in the event scheduling ruleset for the second event defines the second event to be run on the standard-power thread.

In one or more embodiments, the one or more performance characteristics includes a utilization value of the processor and a user interface (UI) response time associated with the application.

In various embodiments, the reward may be inversely related to the utilization value of the processor and the UI response time associated with the application.

In yet various embodiments, the sustainability logic is further configured to detect the at least one event after learning of the event scheduling ruleset. Upon the detection of at least one event, the at least one event is scheduled to run on one of the low-power thread or the standard-power thread based on the event scheduling ruleset.

In numerous embodiments, the at least one event is scheduled to run on the standard-power thread based on a rule in the event scheduling ruleset defining a higher preference for the standard-power thread than the low-power thread for the at least one event.

In numerous additional embodiments, the at least one event is scheduled to run on the low-power thread based on a rule in the event scheduling ruleset defining a higher preference for the low-power thread than the standard-power thread for the at least one event.

In additional embodiments, the sustainability logic is further configured to run the at least one event on one of the low-power thread or the standard-power thread based on the scheduling.

In further embodiments, the low-power thread corresponds to a low priority, throttled thread that has lower energy consumption compared to the standard-power thread.

In further additional embodiments, the device corresponds to a computing device that runs the application and the plurality of events may include two or more of: a network event, an operating system event, a timer event, a communication event, a collaboration event, a security event, or a user input event.

In many further embodiments, the reinforcement learning process may correspond to a model-free reinforcement learning process.

In many additional embodiments, a device includes a processor configured to execute an application associated with a plurality of events, and memory communicatively coupled to the processor. The memory includes a sustainability logic that is configured to detect at least one event of the plurality of events, run the at least one event on one of a low-power thread or a standard-power thread based on an event scheduling ruleset. The event scheduling ruleset is based on a reinforcement learning process that is iteratively performed over a time period for the application, and the event scheduling ruleset defines whether to run an event of the plurality of events on the low-power thread or the standard-power thread.

In an embodiment, a method, at computing device that runs an application associated with a plurality of events, comprises iteratively performing a reinforcement learning process over a time period for the application, learning, based on the iteratively performed reinforcement learning process, an event scheduling ruleset for the application that defines whether to run an event of the plurality of events on a low-power thread or a standard-power thread, and scheduling at least one event of the plurality of events based on the learned event scheduling ruleset.

In yet additional embodiments, the method further includes running the at least one event on one of the low-power thread or the standard-power thread based on the scheduling.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a sustainability logic may operate in accordance with various embodiments of the disclosure;

FIG. 2 is a conceptual schematic diagram of a computing device with machine learning-based event scheduling and energy optimization in accordance with various embodiments of the disclosure;

FIG. 3 is a block diagram illustrating a workflow for a reinforcement learning process in accordance with various embodiments of the disclosure;

FIG. 4 is a diagram depicting various subsets of artificial intelligence in accordance with various embodiments of the disclosure;

FIG. 5 is a conceptual illustration of a supervised learning system in accordance with various embodiments of the disclosure;

FIG. 6 is a conceptual illustration of a machine learning lifecycle in accordance with various embodiments of the disclosure;

FIG. 7 is a conceptual schematic diagram of a neural network in accordance with various embodiments of the disclosure;

FIG. 8 is a flowchart depicting a process for machine learning-based event scheduling and energy optimization in accordance with various embodiments of the disclosure;

FIG. 9 is a flowchart depicting a process for machine learning-based event scheduling and energy optimization in accordance with various embodiments of the disclosure;

FIG. 10 is a flowchart depicting a process for implementing event execution using a learned event scheduling ruleset in accordance with various embodiments of the disclosure; and

FIG. 11 is a conceptual block diagram of a device suitable for configuration with a sustainability logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide a framework for scheduling various events related to collaboration applications or other latency-sensitive real-time applications running on a computing device to optimize energy consumption. The rapid growth of internet connectivity has revolutionized communication and interaction through collaboration applications. However, this surge in collaboration application usage may have a significant environmental impact, as these collaboration applications rely heavily on energy-intensive infrastructure such as data centers, cloud services, and user devices. Devices such as laptops, desktops, or smartphones which are heavily utilized for virtual meetings and collaborative tasks, account for a significant portion of the overall carbon emissions in the digital ecosystem. The present disclosure provides a framework that incorporates a learning-based decision-making mechanism to dynamically allocate resources for executing events related to a collaboration application, optimizing energy consumption while maintaining application performance.

A “collaboration application” may correspond to a software tool (e.g., a computing workload) that facilitates real-time communication and collective interaction among multiple users, over a network. Unlike regular software applications/tools, which primarily focus on single-user tasks, a collaboration application may integrate real-time messaging, voice/video calls, and document co-authoring features. In an example, collaboration applications may be referred to as latency-sensitive real-time collaboration applications based on their requirement of low latency and real-time/near-real time interactions involving instant communication, live collaboration, or dynamic content updates.

In many embodiments, a computing device may include a sustainability logic, embodied within a memory of the computing device or as a standalone component, that enables adaptive event management for the collaboration application and other latency-sensitive real-time applications running on the computing device. In a variety of embodiments, the computing device may include one or more processors that are configured to run the collaboration application.

In a number of embodiments, the collaboration application may be associated with a plurality of events, which occur to support real-time or near real-time communication, data synchronization, and collaboration among multiple user devices. For example, the plurality of events may include network events, operating system events, timer event, communication events, collaboration events, security events, user input events, or the like.

In various embodiments, the sustainability logic may utilize a learning-based decision-making mechanism, for example, a reinforcement learning process, to learn whether to run a particular event of the plurality of events on a low-power thread or a standard-power thread. Over time, the sustainability logic adjusts thread allocation patterns to learn a balance between user experience responsiveness and overall CPU usage/power consumption.

Thus, in a number of embodiments, the sustainability logic may iteratively perform the reinforcement learning process over a time period (e.g., learning/training phase) for the collaboration application. Thus, during the time period, if an event associated with the collaboration application is received, the sustainability logic may perform an action, which may include one of running the received event on the low-power thread or running the received event on the standard-power thread. Upon performing the action, the sustainability logic may obtain one or more performance characteristics associated with the one or more processors, the collaboration application, the memory, or the like to understand an outcome or impact of the action. Based on these obtained performance characteristics, the sustainability logic may determine a reward of the performed action for the received event and store the received event, the performed action, and the determined reward in a decision database. The reward may indicate whether performing the action has adversely or beneficially impacted the performance characteristics. In a non-limiting example, the sustainability logic may utilize a low-power thread to perform the reinforcement learning process over the time period.

Based on iteratively performing the reinforcement learning process over the time period, performance characteristics data for various actions performed for the plurality of events accumulate in the decision database. Based on the decision database at the end of the time period, the sustainability logic may learn an event scheduling ruleset for the collaboration application that defines whether to run a particular event of the plurality of events on the low-power thread or the standard-power thread. In many examples, the event scheduling ruleset may aggregate various records pertaining to each event of the plurality of events and indicate a thread scheduling preference (one of the low-power thread or the standard-power thread) for each event. In further examples, the event scheduling ruleset may indicate a thread scheduling choice (one of the low-power thread or the standard-power thread) for each event of the plurality of events. By analyzing the performance characteristics of the actions during the leaning phase, the sustainability logic may refine the event scheduling ruleset iteratively, ensuring optimal resource allocation for future events. Thus, the reinforcement learning process may enable continuous improvement in event scheduling.

In more embodiments, after the reinforcement learning process is complete and the event scheduling ruleset is learned, if the sustainability logic detects at least one event of the plurality of events, the sustainability logic may schedule the detected event based on the learned event scheduling ruleset (implementation phase). In other words, the sustainability logic may schedule the detected event to run on one of the low-power thread or the standard-power thread as indicated in the event scheduling ruleset and then run the detected event based on the scheduling.

In addition to improving energy efficiency while maintaining application performance, the present disclosure may contribute in reducing environmental impact by lowering carbon emissions. For example, energy consumption in the computing devices may be directly linked to greenhouse gas emissions, particularly in devices powered by electricity sourced from fossil fuels. Thus, by optimizing resource allocation for event execution, the present disclosure may also reduce energy usage, which in turn may reduce the overall power demand of the computing device.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

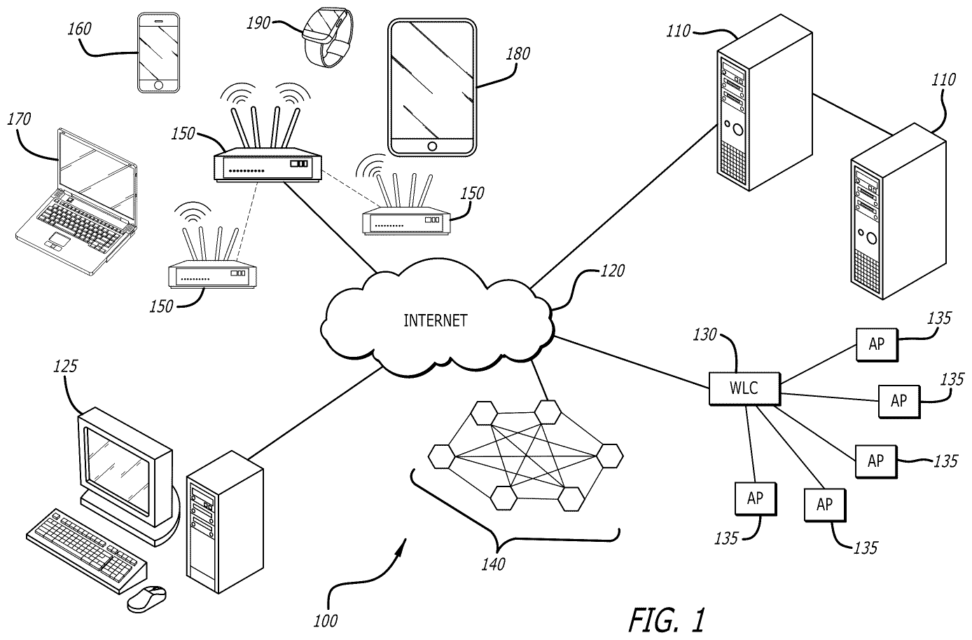

Referring to FIG. 1, a conceptual network diagram 100 of various environments in which a sustainability logic may operate in accordance with various embodiments of the disclosure is shown. Those skilled in the art will recognize that the sustainability logic can include various hardware and/or software deployments and can be configured in a variety of ways. In many embodiments, the sustainability logic can be configured as a standalone device, exist as a logic in another computing device or distributed among various computing devices, or be remotely operated as part of a cloud-based service tool. In further embodiments, one or more servers 110 can be configured with the sustainability logic or can otherwise operate as the sustainability logic. In many embodiments, the one or more servers 110 may be connected to a communication network 120 (shown as the “Internet”). The communication network 120 can include wired networks or wireless networks. The sustainability logic can be provided as a cloud-based service that can service remote computing devices, such as, but not limited to a deployed computing device network 140.

However, in additional embodiments, the sustainability logic may be operated as a distributed logic across multiple computing devices communicatively coupled to a plurality of APs 150 directly coupled to the communication network 120 or APs 135 coupled to the communication network 120 via a wireless LAN controller (WLC) 130. The APs 150, 135 may facilitate Wi-Fi connections for the computing devices, such as but not limited to, mobile computing devices including laptop computers 170, cellular phones 160, portable tablet computers 180, and wearable computing devices 190. In still more embodiments, the sustainability logic may be integrated into laptop computers 170, cellular phones 160, portable tablet computers 180, and wearable computing devices 190. In example embodiments, a personal computer 125 may be utilized to access and/or manage various aspects of the sustainability logic, either remotely or within the network itself. In the embodiment depicted in FIG. 1, the personal computer 125 may communicate over the communication network 120 and can access the sustainability logic of other computing devices.

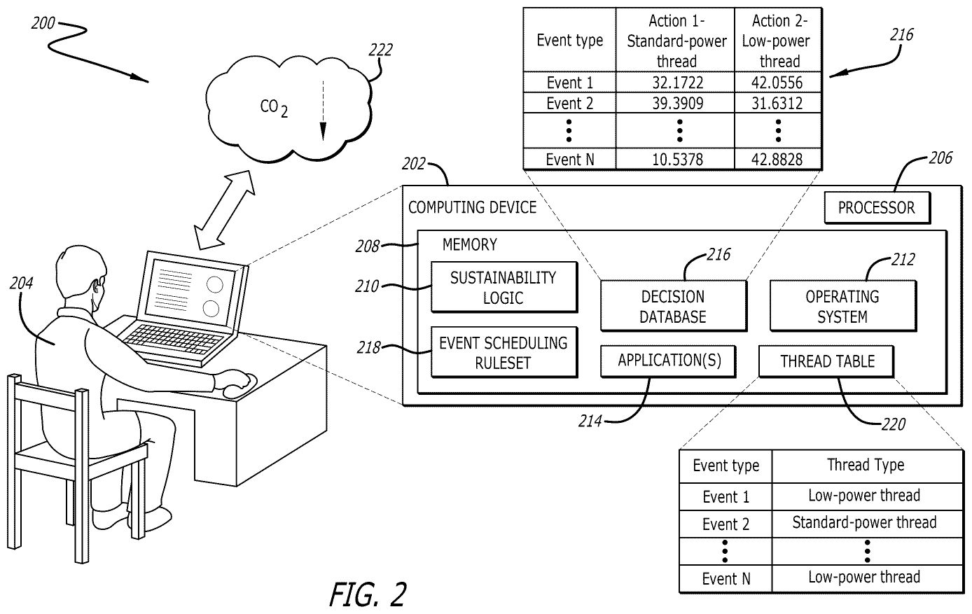

Although a specific embodiment for various environments that the sustainability logic may operate on a plurality of computing/electronic devices suitable for carrying out the various steps, processes, methods, and operations described herein is discussed with respect to FIG. 1, any of a variety of systems and/or processes may be utilized in accordance with embodiments of the disclosure. In many non-limiting examples, the sustainability logic may be provided as a device or software separate from the computing devices. The elements depicted in FIG. 1 may also be interchangeable with other elements of FIGS. 2-11 as required to realize a particularly desired embodiment.

Referring to FIG. 2, a conceptual schematic diagram 200 of a computing device with machine learning-based event scheduling and energy optimization in accordance with various embodiments of the disclosure is shown. Embodiments of FIG. 2 depict a computing device 202 accessed by a user 204, with one or more latency-sensitive real-time applications (shown and referred to as “applications 214” in FIG. 2) installed. Examples of the computing device 202 may include desktops, laptops, computers, smartphones, tablets, wearable devices, smart televisions, smart displays, real-time multiplayer gaming consoles, or the like.

In many embodiments, the computing device 202 may include a processor 206 and a memory 208. The processor 206 may include suitable logic, circuitry, and interfaces that are configured to execute instructions stored in the memory 208. The processor 206 may correspond to an Application-Specific Integrated Circuit (ASIC) processor, a Complex Instruction Set Computing (CISC) processor, a Central Processing Unit (CPU), an Explicitly Parallel Instruction Computing (EPIC) processor, a Very Long Instruction Word (VLIW) processor, or other processors or circuits. The memory 208 may include suitable logic, circuitry, and interfaces that are configured to store a machine code or the instructions executable by the processor 206. The memory 208 may correspond to a Random Access Memory (RAM), a Read Only Memory (ROM), an Electrically Erasable Programmable Read-Only Memory (EEPROM), a Hard Disk Drive (HDD), a Solid-State Drive (SSDs), Secure Digital (SD) card, cloud-based memory, or distributed memory. The computing device 202 may include various other components such as input/output interfaces, network interface controllers, storage controllers, or the like, in addition to the processor 206 and the memory 208; however, these are not shown in FIG. 2 for the sake of brevity.

In a variety of embodiments, the memory 208 may include a sustainability logic 210, an operating system 212, and the application(s) 214. The sustainability logic 210 may correspond to a set of instructions stored in the memory 208 that, when executed by the processor 206, cause the processor 206 to carry out various sustainability related operations. Though the sustainability logic 210 is shown to be stored or included within the memory 208, the scope of the disclosure is not limited to it. The sustainability logic 210 can also be embodied or included in the processor 206 or as a standalone component in the computing device 202, or be provided as a cloud-based service accessed by the computing device 202 over a communication network, such as Internet.

In more embodiments, the operating system 212 may refer to a layer of software in the computing device 202 that may be configured to manage one or more hardware resources (such as the processor 206 and the memory 208) and provide essential services for running the application(s) 214 on the computing device 202. The operating system 212 may be further configured to control various processes such as memory management, file storage, input/output operations, and device communication in the computing device 202. The operating system 212 may serve as an interface between the hardware components (e.g., such as the processor 206, the memory 208, etc.), ensuring the hardware components function in collaboration. The operating system 212 may be configured to handle task scheduling, allowing the application(s) 214 to run simultaneously without conflicts by allocating processor, memory, and clock resources as needed.

In yet more embodiments, the processor 206 may be configured to execute the application(s) 214, utilizing various system resources such as the memory 208, storage, and network connectivity. The application(s) 214 may be configured to interact with various hardware components of the computing device 202 through the operating system 212, executing respective functions based on one or more user inputs of the user 204 or system triggers. The application(s) 214 may be configured to handle data processing, synchronization, and communication with external services or devices. In still more embodiments, the application(s) 214 may include one or more latency-sensitive real-time applications.

Latency-sensitive real-time application may correspond to a computing workload that involves real-time or near real-time data processing and minimal delay (for example, tens to few hundreds of milliseconds) to maintain functionality and user experience. Latency-sensitive real-time application may rely on low-latency networks and real-time or near real-time data synchronization. Various examples of latency-sensitive real-time applications may include collaboration applications, cloud-based interactive applications, multi-player real-time gaming applications, or the like. Unlike regular applications, which can tolerate delays in processing or network communication (e.g., email clients, word processors, or offline applications), performance of the latency-sensitive real-time applications can degrade if latency exceeds configured threshold limits.

Collaboration application may refer to a type of latency-sensitive real-time application that facilitates real-time communication and collective work among multiple user devices, over a network. Unlike regular applications/tools, which primarily focus on single-user tasks, a collaboration application may integrate real-time messaging, voice/video calls, and document co-authoring features. Collaboration application may rely on a cloud-based architecture for multi-device syncing and remote access to shared resources. Further, collaboration application may also use event-driven architecture, where user actions (such as sending messages, joining meetings, or editing documents) trigger real-time or near real-time updates to other remote users. Furthermore, collaboration application may handle network dependency, ensuring performance even with varying network conditions, and can provide offline functionality with subsequent synchronization once online. Collaboration application may also offer third-party integrations with various cloud services, providing centralized workflows. Collaboration application may implement various security and compliance standards, such as end-to-end encryption and enterprise-level access control, for multi-user environments.

In still yet more embodiments, the sustainability logic 210 may be configured to provide a framework that incorporates a learning-based decision-making mechanism to dynamically allocate resources for executing events related to the application(s) 214, optimizing energy consumption while maintaining application performance. For the sake of brevity, the ongoing description is described with respect to a single application 214 among the application(s) 214.

In several embodiments, the application 214 may be associated with a plurality of events, which occur to support real-time or near real-time communication, data synchronization, and/or collaboration among multiple user devices. For example, the plurality of events may include network events, operating system events, timer event, communication events, collaboration events, security events, user input events, or the like.

Network events may relate to one or more interactions between the executed application 214 and underlying network infrastructure, such as sending, receiving, and routing data packets. Network events may include the establishment and maintenance of connections for communication sessions, such as video calls or messaging. Examples of network events may include, but not limited to, sending an HTTP request, receiving a WebSocket message, or handling network issues like bandwidth fluctuations affecting call quality.

Operating system events may be triggered based on interactions of the application 214 with the operating system 212, such as resource management, system state changes, or hardware interactions. Examples of the operating system events may include memory allocation, processor utilization, device sleep/wake state, or CPU performance changes.

Timer events may correspond to events driven by specific time intervals or deadlines within the application 214. In an example, the timer events may be utilized for automation or periodic checks for various tasks related to the application 214. For example, a timer event may trigger the application 214 to refresh a chat feed, check for new notifications, send reminders, or automatically log out the user 204 after a configured period of inactivity.

Communication events may be related to an exchange of information between various users within the application 214, specifically around sending and receiving messages, initiating or terminating voice/video calls, and other forms of synchronous communication. Examples of the communication events may include sending a chat message, receiving a notification for a missed call, a voice call being answered or dropped, etc.

Collaboration events may be related to multi-user interactions, for examples, actions that involve collaborative efforts between multiple user devices running the application 214, such as editing shared documents, uploading or downloading files, or updating shared task lists. Examples of the collaboration events may include a user typing in a shared document, updating the status of a project task, or a colleague modifying a file in a collaborative workspace.

Security events may involve monitoring of the application 214 security and user authentication, including checks for unauthorized access, encryption, and data integrity. Examples of the security events may include a failed login attempt, user authentication token refresh, or an encryption key change when transmitting sensitive data during a collaboration session of the application 214. Security events may enable real-time synchronization and coordination across multiple devices.

User input events may capture direct actions performed by the user 204 on a user interface of the application 214, for example, mouse clicks, keyboard inputs, touchscreen gestures, or the like. Additional examples may include clicking a button to join a meeting, typing a message in a chat window, or selecting a file to upload during a shared document editing session.

In further embodiments, the sustainability logic 210 may be configured to utilize the learning-based decision-making mechanism, for example, a reinforcement learning process, to learn whether to run a particular event of the plurality of events on a low-power thread or a standard-power thread. In an example, the low-power thread may correspond to a low priority, throttled background thread that has lower energy consumption compared to the standard-power thread. Further, the standard-power thread may correspond to a high-priority foreground thread. The decision whether to run an event on the low-power thread or the standard-power thread may be a function of user experience responsiveness and overall CPU usage, along with several other factors that can influence both efficiency and environmental impact. If all events associated with the application 214 are run on standard-power threads, it may lead to increased carbon emissions due to higher energy consumption, while excessive dependency on low-power threads may lead to noticeable delays in application performance. Thus, over time, the sustainability logic 210 may be configured to adjust thread allocation patterns to learn a balance between user experience responsiveness and overall CPU usage. In a non-limiting example, the reinforcement learning process performed by the sustainability logic 210 may correspond to a model-free reinforcement learning process. Model-free reinforcement learning process corresponds to a type of reinforcement learning where an agent learns optimal behavior through direct interaction with the environment (for example, the application 214) without requiring a predefined model of the environment's dynamics. Model-free reinforcement learning process may rely on trial-and-error experiences to estimate value functions or directly optimize policies.

Thus, in numerous embodiments, the sustainability logic 210 may be configured to iteratively perform the reinforcement learning process over a time period (e.g., learning/training phase) for the application 214. During the time period, if an event associated with the application 214 is received, the sustainability logic 210 may be configured to perform an action based on the received event. The action may include one of running the received event on the low-power thread or running the received event on the standard-power thread. Upon performing the action, the sustainability logic 210 may be further configured to obtain one or more performance characteristics associated with the processor 206, the application 214, the memory 208, or the like to understand an outcome or impact of the action. Based on these obtained performance characteristics, the sustainability logic 210 may be further configured to determine a reward of the performed action for the received event and store the received event (e.g., an event identifier), the performed action, and the determined reward in a decision database 216 stored in the memory 208. The reward may indicate whether performing the action has adversely or beneficially impacted the performance characteristics.

In an example embodiment, the one or more performance characteristics may include a utilization value of the processor 206 and a user interface (UI) response time associated with the application 214. In such a scenario, the reward may be defined as a function of the utilization value of the processor 206 and the UI response time associated with the application 214. For example, reward function may be inversely related to the utilization value of the processor 206 and the UI response time associated with the application 214 as indicated in equation 1 below:

$$Reward = \frac{1}{CPU Utilization \times UI Response Time} \qquad ( 1 )$$

Thus, to determine the reward of the performed action for the received event, the sustainability logic 210 may obtain the utilization value of the processor 206 and the UI response time associated with the application 214 after performing the action. The sustainability logic 210 can obtain the utilization value of the processor 206 from various system performance monitoring sources such as operating system's task manager, performance counters, telemetry tools, or the like. Similarly, the sustainability logic 210 can obtain the UI response time associated with the application 214 from system monitoring and event-tracing mechanisms (such as watchdog timers), application layer which can track unresponsive UI states of the application 214, or the like. In an example, the action of running the received event on the low-power thread may result in reduction of the utilization value of the processor 206 while maintaining the UI response time below a maximum allowed response time threshold limit. In this scenario, the reward may indicate that the action has beneficially impacted the performance characteristics. Likewise, if running the received event on the low-power thread reduces the utilization value of the processor 206 but increases the UI response time beyond the maximum allowed response time threshold limit, the reward may indicate that the action has adversely impacted the performance characteristics. In several embodiments, the reward may be a numerical value that is a function of the performance characteristics. Though the equation 1 describes the reward as function of the utilization value of the processor 206 and the UI response time of the application 214, the scope of the disclosure is not limited to it. The reward function can depend on various other performance characteristics that directly or indirectly impact the UI response time and carbon footprint of the computing device 202.

In a non-limiting example, the sustainability logic 210 may utilize a low-power thread to perform the reinforcement learning process over the time period. Since the same event can occur multiple times during the time period (e.g., training phase) under varying application usage conditions, the rewards of the same action can differ even for the same event at different time instances. Thus, based on iteratively performing the reinforcement learning process over the time period, reward data regarding various actions performed for the plurality of events is accumulated in the decision database 216. In additional embodiments, the decision database 216 may correspond to a tabular database with each row indicating a reward of a particular action for a particular received event. For example, as shown in FIG. 2, a first row of the decision database 216 indicates a reward of “32.1722” of running “Event 1” on a standard-priority thread at a first time instance in the time period, compared to a reward of “42.0556” of running the same “Event 1” on a low-power thread at a second time instance in the time period. Likewise, a second row of the decision database 216 indicates a reward of “39.3909” of running “Event 2” on a standard-priority thread, compared to a reward of “31.6312” of running the same “Event 2” on a low-power thread. Similarly, an N^{th} row of the decision database 216 indicates a reward of “10.5378” of running “Event N” on a standard-priority thread, compared to a reward of “42.8828” of running the same “Event N” on a low-power thread. Thus, the decision database 216 at the end of time period can have multiple rows for the plurality of events and corresponding reward values of performed actions. In further embodiments, the sustainability logic 210 may determine that the learning phase is complete in response to stabilization in the reward values, for example, in response to the performed actions yielding substantially same reward values for the plurality events as before.

In further additional embodiments, based on the iteratively performed reinforcement learning process and the decision database 216 at the end of the time-period (e.g., end of the learning phase), the sustainability logic 210 may be further configured to learn an event scheduling ruleset 218 for the application 214 that defines whether to run a particular event of the plurality of events on the low-power thread or the standard-power thread. In an example, the decision database 216 may have multiple records of running a first event and a second event of the plurality of events on both the low-power thread and the standard-power thread. Thus, if the decision database 216 specifies that running the first event on the low-power thread has a higher reward than running the first event on the standard-power thread, a first rule in the event scheduling ruleset 218 for the first event may define a higher preference to run the first event on the low-power thread compared to running the first event on the standard-power thread. Likewise, if the decision database 216 specifies that running the second event on the low-power thread has a lower reward than running the second event on the standard-power thread, a second rule in the event scheduling ruleset 218 for the second event may define a higher preference to run the second event on the standard-power thread compared to running the second event on the low-power thread. In other words, the event scheduling ruleset 218 may aggregate various records pertaining to each event of the plurality of events and indicate a thread scheduling preference for each event. In further examples, if the decision database 216 specifies that running the first event on the low-power thread has a higher reward than running the first event on the standard-power thread, a first rule in the event scheduling ruleset 218 for the first event may define the first event to be run on the low-power thread. Likewise, if the decision database 216 specifies that running the second event on the low-power thread has a lower reward than running the second event on the standard-power thread, a second rule in the event scheduling ruleset 218 for the second event may define the second event to be run on the standard-power thread. In other words, the event scheduling ruleset 218 may indicate a thread scheduling choice for each of the plurality of events.

In the non-limiting example shown in FIG. 2, since the decision database 216 specifies that running “Event 1” on the low-power thread has a higher reward than running “Event 1” on the standard-power thread, the event scheduling ruleset 218 may define “Event 1” to be run on the low-power thread, whereas the event scheduling ruleset 218 may define “Event 2” to be run on the standard-power thread considering the decision database 216 has a higher reward for running “Event 2” on the standard-power thread than the low-power thread.

In yet further embodiments, the sustainability logic 210 may store the event scheduling ruleset 218 in the memory 208. Thus, the reinforcement learning process may enable continuous improvement in event scheduling. By analyzing the performance characteristics of the actions during the leaning phase, the sustainability logic 210 may refine the event scheduling ruleset 218 iteratively, ensuring optimal resource allocation for future events.

In more embodiments, after the learning of the event scheduling ruleset 218 at the end of the time period, if the sustainability logic 210 detects at least one event of the plurality of events, the sustainability logic 210 may be configured schedule the detected event based on the learned event scheduling ruleset 218 (implementation phase). In other words, the sustainability logic 210 may schedule the detected event to run on one of the low-power thread or the standard-power thread as indicated in the event scheduling ruleset 218 and then run the detected event based on the scheduling. For example, a rule in the event scheduling ruleset 218 may define a higher preference for the standard-power thread than the low-power thread for the detected event. As a result, the detected event may be scheduled to run on the standard-power thread. Likewise, a rule in the event scheduling ruleset 218 may defines a higher preference for the low-power thread than the standard-power thread for the detected event. In such a scenario, the detected event may be scheduled to run on the low-power thread. In still further embodiments, the memory 208 may be configured to store a thread table 220 that indicates scheduling decision for each detected event. For example, as shown in FIG. 2, since the event scheduling ruleset 218 defines a higher preference for the low-power thread than the standard-power thread for “Event 1”, the sustainability logic 210, upon detecting the “Event 1”, may schedule the “Event 1” to run on the low-power thread. Likewise, the sustainability logic 210, upon detecting the “Event 2” and “Event N”, may schedule the “Event 2” and “Event N” to run on the standard-power thread and the low-power thread, respectively. Thus, the thread table 220 may indicate scheduling decisions for Event 1”, “Event 2”, and “Event N” as “low-power thread”, “standard-power thread”, and “low-power thread”, respectively.

In numerous additional embodiments, optimized event scheduling based on the learned event scheduling ruleset 218 may result in reduction in energy consumption by the computing device 202 due to running of the application 214, which may directly or indirectly contribute to lowering carbon emissions 222. For example, by prioritizing energy-efficient thread allocation, the sustainability logic 210 may reduce power usage at device level, which can translate into reduced greenhouse gas emissions for the device, while maintaining application performance and seamless user experience.

Although a specific embodiment for a computing device with machine learning-based event scheduling and energy optimization suitable for carrying out the various steps, processes, methods, and operations described herein is discussed with respect to FIG. 2, any of a variety of systems and/or processes may be utilized in accordance with embodiments of the disclosure. For example, during the learning phase, the sustainability logic 210 can also determine reward of an action for a received event based on real-time user feedback. For example, the sustainability logic 210 may receive a video playback request as an event, and run the video playback on a low-power thread. Upon running the video playback on the low-power thread, the sustainability logic 210 may prompt the user 204 to provide a feedback on user experience related to the video playback. In a case where the user 204 provides a positive feedback, the sustainability logic 210 may increase the reward of the performed action. Alternatively, if the user 204 provides a negative feedback on user experience, the sustainability logic 210 may decrease the reward of the performed action. The elements depicted in FIG. 2 may also be interchangeable with other elements of FIGS. 1 and 3-11 as required to realize a particularly desired embodiment.

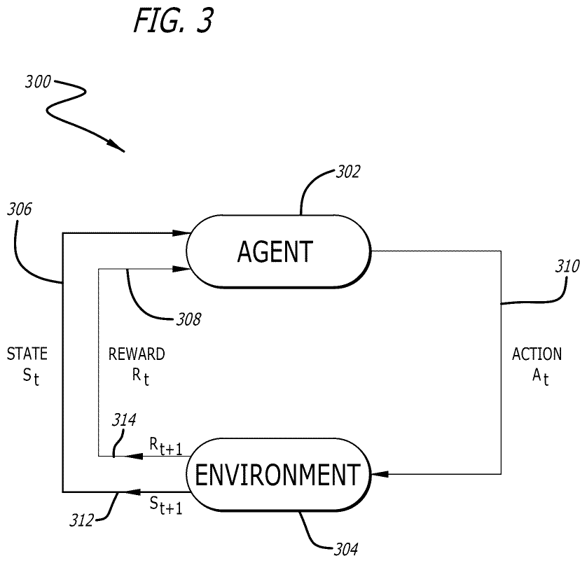

Referring to FIG. 3, a block diagram illustrating a workflow 300 for a reinforcement learning process in accordance with various embodiments of the disclosure is shown. Reinforcement learning may comprise a type of machine learning technique that may be implemented by an agent 302 to learn by trial and error in a dynamic environment 304 using feedback from actions performed by the agent 302. An event scheduling and energy optimization framework for a computing device may be based, for example, on the reinforcement learning process. In an example, the agent 302 may correspond to a sustainability logic implemented on the computing device and the environment 304 may correspond to the computing device executing a latency-sensitive real-time application (e.g., a collaboration application).

In the example workflow 300, the agent 302 may perform an action at time ‘t’ (e.g., an action Aₜ 310) based on a state of the environment 304 at time ‘t’ (e.g., a state St 306). In an example, state Sₜ 306 may correspond to a received event associated with the collaboration application. The action Aₜ 310 may influence a future state of the environment 304 at a future time ‘t+1’ (e.g., a future state Sₜ₊₁ 312). Additionally, the agent 302 may receive a reward Rₜ 308 from the environment 304 indicating a success of action Aₜ 310. The goal of the agent 302 may be to determine an optimal action for a received event that maximizes rewards received from the environment 304.

Thus, the agent 302 may iteratively learn an optimal event scheduling ruleset by interacting with the environment 304. Given a discrete set of states (e.g., a plurality of events associated with the collaboration application), available actions (e.g., running an event on one of low-power thread or a standard-power thread) within each state, and a reward function that evaluates the outcomes of actions, the agent 302 may learn maximize cumulative future rewards (reward Rₜ₊₁ 314) over time.

Although a specific embodiment of a workflow for a reinforcement learning process suitable for carrying out the various steps, processes, methods, and operations described herein is discussed with respect to FIG. 3, any of a variety of systems and/or processes may be utilized in accordance with embodiments of the disclosure. In an example, the agent 302 may utilize Bellman equation, Markov Decision Process, etc., for the learning of optimal actions for the states. The elements depicted in FIG. 3 may also be interchangeable with other elements of FIGS. 1-2 and 4-11 as required to realize a particularly desired embodiment.

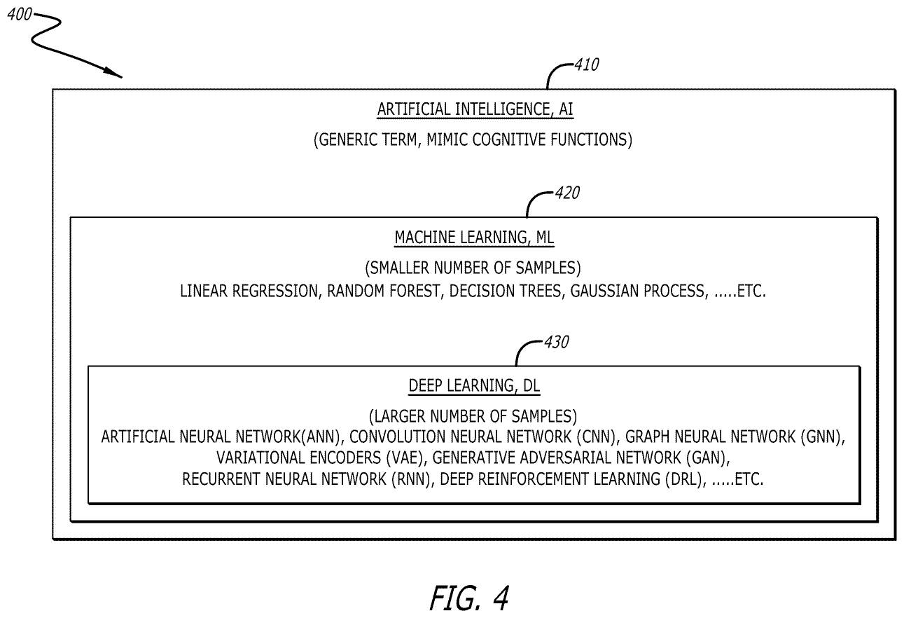

Referring to FIG. 4, a diagram 400 depicting various subsets of artificial intelligence in accordance with various embodiments of the disclosure is shown. Artificial intelligence (AI) 410 is typically understood in the art to be the development of machines and algorithms that mimic human intelligence, for example, by optimizing actions to achieve certain goals. At its core, AI 410 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 410 can be considered a generic term because it encompasses a wide range of subfields and techniques, from simple rule-based systems to advanced machine learning and deep learning models. These AI techniques are used to simulate various aspects of human cognition. For example, machine learning (ML) 420 allows computers to learn from data patterns without explicit programming for each task, while natural language processing (NLP) enables machines to understand and generate human language. Deep learning (DL) 430, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 410 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 420 is a subset of Artificial Intelligence (AI) 410 that focuses on the development of algorithms and statistical models that enable computers to learn and make decisions from data without explicit programming. In traditional programming, a computer is given a fixed set of rules to follow, but ML 420 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to dynamically schedule events to improve energy efficiency and reduce carbon footprint, while maintaining application responsiveness in computing devices.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 420. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from a decision database including rewards for performing various actions related to a plurality of events of a collaboration application executed on the computing device.

However, traditional ML methods rely heavily on feature engineering, wherein human experts manually identify the most relevant features or patterns within the data. For example, when using ML 420 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 430 is a specialized subset of Machine Learning (ML) 420 that employs multi-layered artificial neural networks to automatically learn complex patterns and representations from large, often unstructured datasets. Inspired by the way the human brain processes information, DL 430 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 430 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 420 neural network designed to work particularly well with structured data, making them highly relevant for scheduling events in computing devices. CNN can be leveraged to optimize event scheduling across low-power and high-power threads. By analyzing patterns in historical event execution, resource utilization, and application responsiveness, CNN can be utilized to schedule events, ensuring optimal processing based on workload demands. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as whether to run a detected event on a low-power thread or a high-power thread.

While CNNs are well-suited for structured grid-based data, many real-world problems can involve non-grid data, such event dependencies, resource constraints, or execution flows within a collaboration application. This type of data may better be represented as a graph, where nodes correspond to computational tasks (e.g., events) and edges represent relationships between the tasks. Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is key in predicting properties that depend on the current/local structure, such as the behavior of the computing device.

Generative models aim to learn the underlying patterns of a dataset and generate new samples that resemble the original data. Two common types of generative models are Variational Autoencoders (VAEs) and Generative Adversarial Networks (GANs). In the context of event scheduling, VAEs can be used to model and generate optimal scheduling patterns by encoding event sequences into a lower-dimensional latent space and decoding them back into structured schedules. By sampling from this latent space, new scheduling strategies can be generated dynamically, enabling adaptive optimization of event execution across low-power and high-power threads.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. In the context of event scheduling with a goal to reduce carbon footprint, this adversarial process can be leveraged to optimize event distribution across low-power and high-power threads. A generator can propose scheduling strategies, while a discriminator evaluates their efficiency against real-world execution patterns. Over time, this approach can refine scheduling policies, leading to more efficient and adaptive workload management.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as user interaction.

In application event scheduling, Deep Reinforcement Learning (DRL) can be utilized in scenarios where optimal task allocation decisions need to be made, such as dynamically distributing workloads across low-power and high-power threads to reduce CPU utilization, memory access, or the like while maintaining application responsiveness within defined threshold limits. By combining Reinforcement Learning (RL) with Deep Learning (DL), DRL may enable learning from raw execution data, making it a powerful tool for adaptive and real-time scheduling.

Although a specific embodiment for a diagram 400 depicting various subsets of artificial intelligence suitable for carrying out the various steps, processes, methods, and operations described herein is discussed with respect to FIG. 4, any of a variety of systems and/or processes may be utilized in accordance with embodiments of the disclosure. For example, other subset may be present and available for use within AI 410. Those skilled in the art will recognize that the diagram 400 presented in FIG. 4 is simplified for illustration purposes and various methods and techniques may interact with other areas (ML 420 with DL 430, etc.). The elements depicted in FIG. 4 may also be interchangeable with other elements of FIGS. 1-3 and 5-11 as required to realize a particularly desired embodiment.

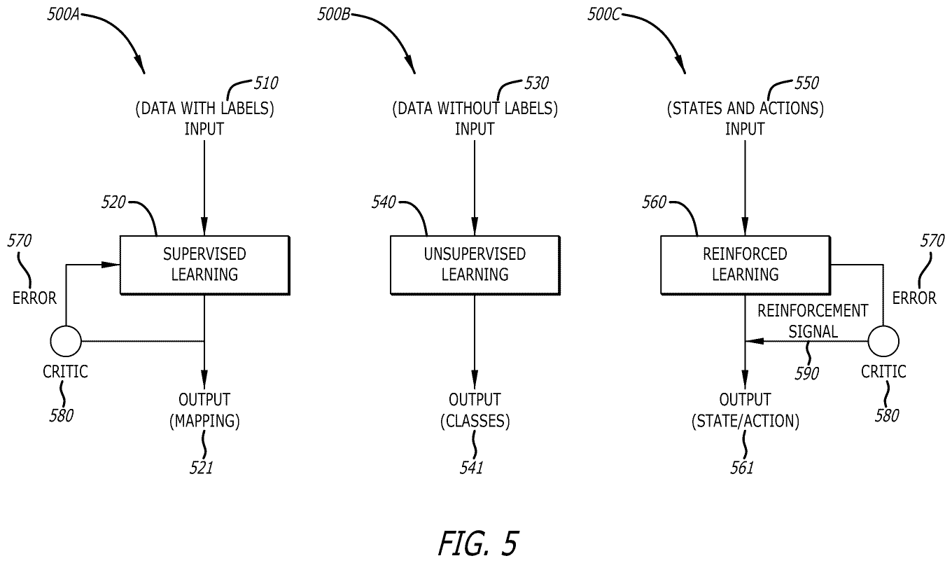

Referring to FIG. 5, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 5, a supervised learning system 500A is shown. The supervised learning system 500A can be configured with a supervised learning model 520 that accepts input data 510 and generates an output 521. However, the output data is often reviewed by a critic 580 that can determine one or more errors 570 that are fed back into the supervised learning model 520 for use in updating.

Supervised learning systems 500A are often considered the simplest machine learning model to understand in which input data (such as training data) has a known label or result as an output. So, the supervised learning model 520 can be understood to work on the principle of input-output pairs. As such, a function can be trained using a training data set, which is then applied to unknown data and makes some predictive performance. Supervised learning is task-based and mostly tested on labeled data sets.

Supervised learning systems 500A may often involve one or more regression problems. In regression problems, the output is a continuous variable. Some commonly used Regression models include linear regression, decision trees, and random forests. Linear regression is typically the most straightforward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to event scheduling with a goal to reduce CPU utilization while maintaining application responsiveness with configured threshold limits. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are the another type of supervised learning, which can be used to generate conclusions from observed values in one or more categorical forms. For example, a classification model can identify if an email is spam or not; whether a current event scheduling decision is suitable for application responsiveness, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify whether to run an event on a low-power thread or a high-power thread based on system performance characteristics.

Again, in the embodiment depicted in FIG. 5, an unsupervised learning system 500B is shown. The unsupervised learning system 500B can be configured with an unsupervised learning model 540 that accepts input data 530 and generates an output 541. Unlike other model types, there are no critics or error signals to process. Unsupervised learning models 540 can implement the learning process opposite to supervised learning, which means it enables the model to learn from an unlabeled training dataset. Based on the unlabeled dataset, the unsupervised learning model 540 can predict the output. Using an unsupervised learning system 500B, the unsupervised learning model 540 can learn hidden patterns from the dataset by itself without any supervision. In various embodiments, unsupervised learning models 540 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to event scheduling for a collaboration application in a computing device to reduce carbon footprint of the computing device due to executing the collaboration application. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 5, a reinforcement learning system 500C is shown. The reinforcement learning system 500C can be configured with a reinforcement learning model 560 that accepts input data 550 and generates an output 561. In reinforcement learning, the reinforcement learning model 560 learns actions for a given set of states that lead to a goal state. In the embodiment depicted in FIG. 5, a critic 580 can receive or otherwise notice an error 570 within the reinforcement learning model 560 actions, and adjust the outcome/output via a reinforcement signal 590 such that the “reward” or “punishment” is adjusted to better model the future behaviors or processing of the reinforcement learning model 560.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value as also described in FIG. 2.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 5, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 5 may also be interchangeable with other elements of FIGS. 1-4 and 6-11 as required to realize a particularly desired embodiment.

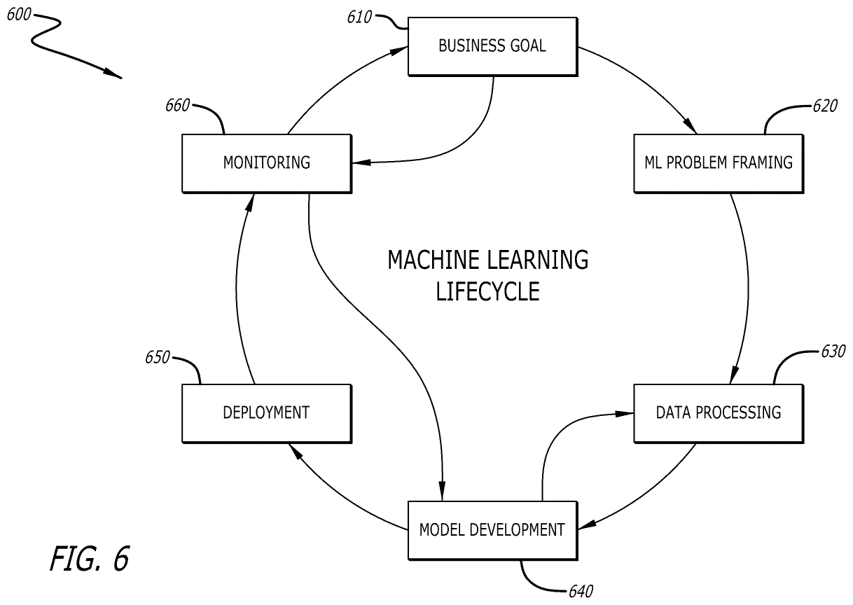

Referring to FIG. 6, a machine learning lifecycle 600 in accordance with various embodiments of the disclosure is shown. During the development of machine learning systems, the embodiment depicted in FIG. 6 can provide a framework for how to structure the design and maintenance of these systems. This machine learning lifecycle 600 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 600 emphasizes that developing a machine learning model is not a one-time effort but an iterative process requiring ongoing monitoring and adjustment. The feedback loop inherent in the machine learning lifecycle 600 allows for continual refinement and optimization of models to maintain their accuracy and relevance.

In many embodiments, a first stage of the machine learning lifecycle 600 is identifying the business goal 610, which sets the overall direction and purpose of the ML project. This can involve understanding the specific problems or opportunities within the business or project that machine learning can address. A clear business goal 610 ensures that the project remains focused on delivering tangible value, whether it is reducing CPU utilization or maintaining application responsiveness within configured threshold limits during event scheduling related to a collaboration application in a computing device. Without a well-defined goal, it can be challenging to align the subsequent stages of the machine learning lifecycle 600, as the choice of model, data processing methods, and performance metrics can all depend on what the business aims to achieve.

Establishing a proper business goal 610 can also involve engaging with key stakeholders and developers to gather requirements and set success criteria. It can provide a roadmap that outlines what success looks like and helps in framing the ML problem. For example, if the goal is to reduce processor utilization while maintaining application responsiveness, the project might focus on building a predictive model that identifies system performance characteristics for running a detected event of the collaboration application on a particular thread type such as low-power thread or high-power thread. Clearly defined goals not only help guide the project but also provide benchmarks for evaluating the effectiveness of the deployed model once it enters production.

Once the business goal 610 is established, various embodiments take a next step involving ML problem framing 620, wherein the goal is translated into a specific machine learning task. This can involve selecting the appropriate type of ML problem, such as classification, regression, clustering, or recommendation, and defining the target variables or outputs. For example, if the goal is to reduce processor utilization while maintaining application responsiveness, the problem can be framed as a binary classification task, where the model predicts whether a running a particular event on a low-power thread will cause the collaboration application to slow down such as an increased UI response time. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 630 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 630 can require or at least benefit from careful planning and iterative refinement. Once the data is processed, it is typically split into training, validation, and test sets to develop and evaluate the model, ensuring that it generalizes well to new, unseen data.

Model development 640 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 640, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 630.

In further embodiments, deployment 650 is the stage where the developed model is integrated into the production environment to perform its intended tasks. This phase may involve setting up the necessary infrastructure, such as APIs or cloud-based services, to allow the model(s) to process live data and generate predictions. Deployment 650 can transform the model from a research tool into a functional component of a business process or product, providing real-time insights, automations, or decisions.

Proper deployment 650 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 610.

In more embodiments, monitoring 660 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 660, teams can identify when the model's performance drops and requires retraining or adjustments to align with the evolving data.

Monitoring 660 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 630 and model development 640, to refine the model(s) as needed. This iterative process allows the machine learning system to adapt and maintain its alignment with the original business goal 610 over time.

Although a specific embodiment for a machine learning lifecycle 600 suitable for carrying out the various steps, processes, methods, and operations described herein is discussed with respect to FIG. 6, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 6 may also be interchangeable with other elements of FIGS. 1-5 and 7-11 as required to realize a particularly desired embodiment.

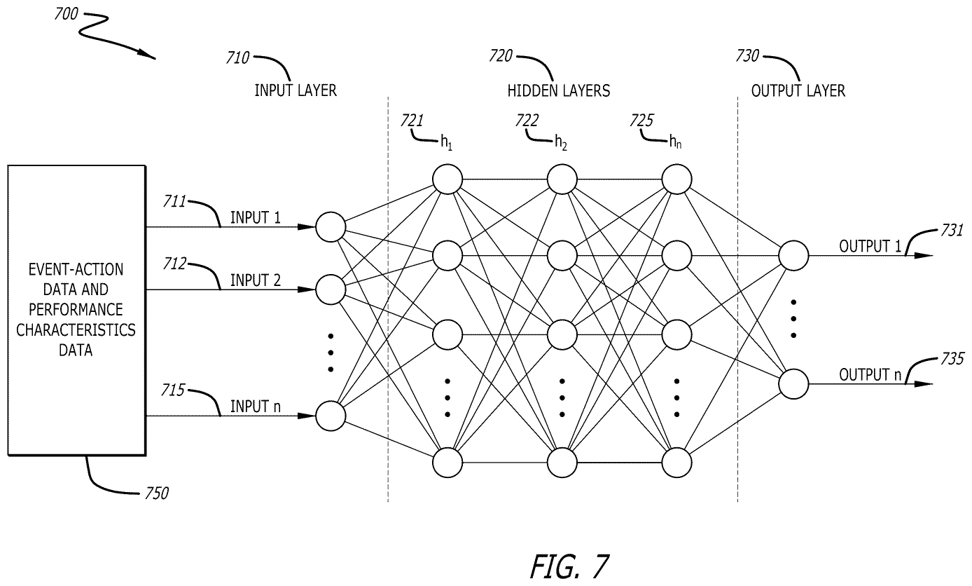

Referring to FIG. 7, an exemplary neural network 700 in accordance with various embodiments of the disclosure is shown. The embodiment depicted specifically depicts a feedforward neural network with multiple layers. This type of network consists of an input layer 10, one or more hidden layers 720, and an output layer 730. Each layer contains nodes (or neurons) that are interconnected, representing how data flows through the network. The input layer 710 can receive raw data, which is then processed by the hidden layers 720 through weighted connections and activation functions. These hidden layers 720 can enable the network to learn complex patterns and relationships within the data.

The final output layer 730 produces the network's predictions or classifications based on the processed input. The interconnected nature of the nodes allows the neural network 700 to learn from data during training by adjusting the weights of connections to minimize prediction errors. This structure is the foundation of deep learning models, as adding more hidden layers 720 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 700 depicted in the embodiment of FIG. 7, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 7 is presented as an exemplary ML solution that may be deployed within one or more methods or systems described herein.

In many embodiments, the input layer 710 is the first layer in a neural network 700 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 700 are generally scaled i.e., normalized to have a zero mean and/or unit standard deviation. Scaling can also be applied to the input of hidden layers (using batch or layer normalization) to improve the stability of neural network 700.

Unlike the hidden layers 720 and output layers 730, the input layer 710 typically does not perform any computations or transformations on the data. Its primary function is often to pass the input data to the next layer in the network, the first hidden layer 721. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 710 itself does not modify the data, it sets the stage for the neural network to extract complex patterns and relationships through the deeper layers. This flexibility in handling various types of input make the neural network 700 a powerful tool for a diverse set of applications.

With respect to the embodiments described herein, the input layer may be configured with a plurality of inputs providing event-action data and performance characteristics data 750, or other data sources. For example, a model can be configured with a first input 711 configured as a first event-action pair, a second input 712 is configured with a first performance characteristic, while additional inputs can be added related to other performance characteristic related to a computing device. The nth input 715 can be configured in certain embodiments to include a current event which is to be scheduled such that a determination whether to run the current event on a low-power thread or a standard-power thread may be possible. However, as those skilled in the art will recognize, additional setups can be configured such that the inputs can be configured to also include different features of a collaboration application, the computing device, etc.

In a number of embodiments, the neural network 700 comprises a plurality of hidden layers 720. The embodiment depicted in FIG. 7 comprises a first hidden layer 721, a second hidden layer 722, and an nth hidden layer 725, which are denoted as h₁, h₂, and hₙ respectively. In many embodiments, the hidden layers 720 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 721 h₁ receives direct input from the input layer, transforming the raw data into an initial set of features. For example, in an image recognition task, this layer might begin identifying basic patterns, such as edges or simple textures. The output of the first hidden layer 721 is then passed to a second hidden layer 722 h₂, which builds upon the features identified by the first hidden layer 721. This deeper layer might start recognizing more complex patterns, such as shapes or specific object components, by combining the lower-level features identified earlier. This can continue on until a last, nth hidden layer 725 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 710 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 730 is often the final layer in a neural network and is responsible for producing the network's predictions or classifications based on the information processed through the previous hidden layers 720. Each neuron in the output layer 730 can represent a specific outcome or category that the model can predict. In the embodiment depicted in FIG. 7, the outputs are labeled as “output 1” 731 to “output n” 735, indicating that the network can be designed to have a varying number of outputs depending on the nature of the problem being solved for. For example, in a binary classification task (e.g., scheduling the event on a low-power thread), there would typically be a single output neuron that provides a probability score for one of the two classes/outcomes such as “Yes” or “No”. In contrast, for multi-class classification (e.g., scheduling the event on a low-power thread or a standard-power thread), the output layer would contain multiple neurons, each corresponding to a different class such as the low-power thread and the standard-power thread.

The number of neurons in the output layer 730 can also designed specifically for other types of tasks, such as regression, where the model can predict continuous values. In such cases, the output layer 730 might contain a single neuron representing a numerical prediction, such as the price of a house or the temperature forecast, etc. Alternatively, in complex applications like multi-label classification (where each input can belong to multiple classes simultaneously), the output layer 730 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 700 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 7, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 7, which is an illustrative example meant to make it easier to explain the basic concepts of neural networks and how they process information. The specific features and functions described herein are not intended to be limiting to this specific embodiment. Additionally, the elements depicted in FIG. 7 may also be interchangeable with other elements of FIGS. 1-6 and 8-11 as required to realize a particularly desired embodiment.

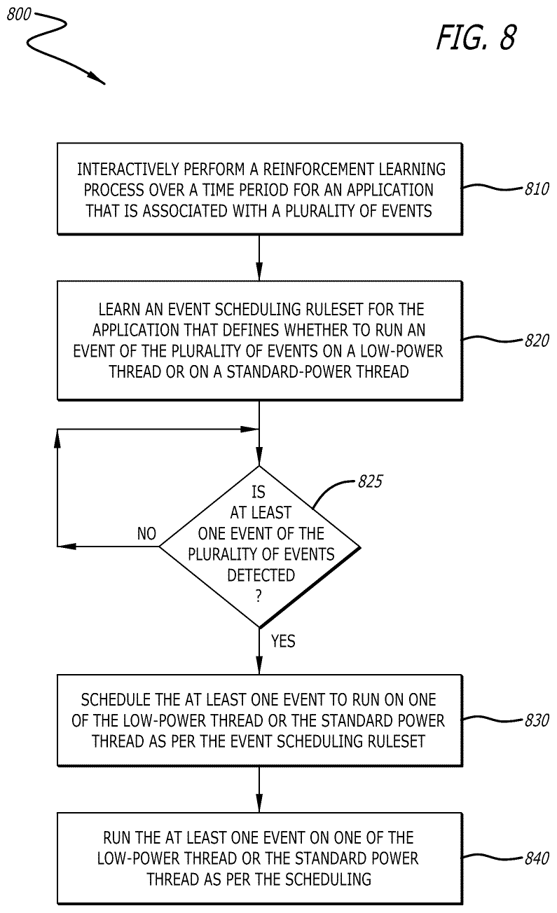

Referring to FIG. 8, a flowchart depicting a process 800 for machine learning-based event scheduling and energy optimization in accordance with various embodiments of the disclosure is shown. In various embodiments, the process 800 may be implemented on a computing device such as a desktop, a laptop, a computer, a smartphone, a tablet, a wearable device, a smart television, a smart display, a real-time multiplayer gaming console, or the like. In various additional embodiments, the process 800 may be executed on a cloud service accessed by the computing device. In many embodiments, the process 800 may iteratively perform a reinforcement learning process over a time period for an application that is associated with a plurality of events (block 810). In a variety of embodiments, the application may be a latency-sensitive real-time application that is run or executed by the computing device. In a number of embodiments, the plurality of events may include two or more of a network event, an operating system event, a timer event, a communication event, a collaboration event, a security event, or a user input event. Examples of the latency-sensitive real-time application may include collaboration applications, cloud-based interactive applications, multi-player real-time gaming applications, or the like, whose performance can degrade if latency exceeds configured threshold limits. In more embodiments, the reinforcement learning process may correspond to a model-free reinforcement learning process. In a non-limiting example, the model-free reinforcement learning process may be Q-learning process.

In a number of embodiments, the process 800 may learn an event scheduling rule set for the application that defines whether to run an event of the plurality of events on a low-power thread or a standard-power thread (block 820). In an example, the low-power thread may correspond to a low priority, throttled thread (e.g., a background thread) that has lower energy consumption compared to the standard-power thread. Further, the standard-power thread may correspond to a high-priority thread (e.g., a foreground thread). Further, the low-power thread may operate with a lower clock speed, reduced CPU voltage, and minimized resource usage as compared to the standard-power thread. Additionally, a low-power thread may have longer sleep interval and reduced wake-up frequency as compared to a standard-power thread. In still more embodiments, a low-power thread may have energy consumption within a first range and a standard-power thread may have energy consumption or resource utilization within a second range, where the second range is higher than the first range. The learned event scheduling ruleset may indicate a thread scheduling choice or preference for each event of the plurality of events.

In additional embodiments, the process 800 can determine if at least one event of the plurality of events is detected (block 825). If no event is detected, the process 800 may continue monitoring for incoming events (block 825). However, if the process 800 determines that at least one event of the plurality of events is detected, in several embodiments, the process 800 may schedule the at least one event to run one of the low-power thread or the standard-power thread, as per the event scheduling ruleset (block 830). For example, a rule in the event scheduling ruleset may define a higher preference for the standard-power thread than the low-power thread for the detected event. As a result, the detected event may be scheduled to run on the standard-power thread. Likewise, a rule in the event scheduling ruleset may defines a higher preference for the low-power thread than the standard-power thread for the detected event. In such a scenario, the detected event may be scheduled to run on the low-power thread.

In numerous embodiments, the process 800 may run the at least one event on one of the low-power thread or the standard-power thread as per the scheduling (block 840). For example, events such as background updates may be run on low-power threads, while user triggered events, such as media playback, may be run on standard-power threads. In additional embodiments, event-thread type pair information may be stored in thread table maintained in a memory of the computing device.

Although a specific embodiment of the process for reinforcement learning-based event scheduling and energy optimization is suitable for carrying out the various steps, processes, methods, and operations described herein is discussed with respect to FIG. 8, any of a variety of systems and/or processes may be utilized in accordance with embodiments of the disclosure. For example, the process 800 can utilize other machine learning based frameworks that can be run on low-power throttled threads on a computing device to learn the event scheduling ruleset. The elements depicted in FIG. 8 may also be interchangeable with other elements of FIGS. 1-7 and 9-11 as required to realize a particularly desired embodiment.

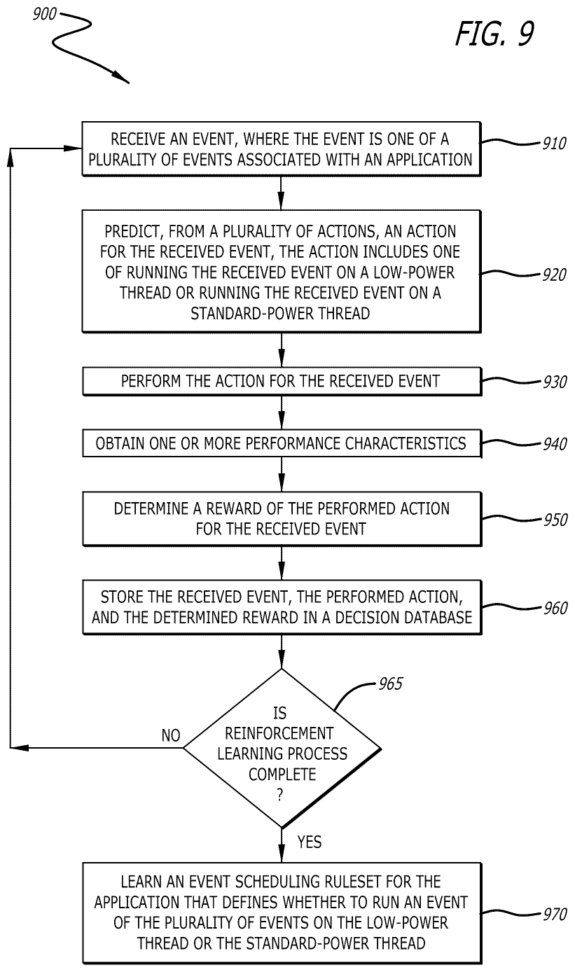

Referring to FIG. 9, a flowchart depicting a process 900 for machine learning-based event scheduling and energy optimization in accordance with various embodiments of the disclosure is shown. In various embodiments, the process 900 may be implemented on a computing device such as a desktop, a laptop, a computer, a smartphone, a tablet, a wearable device, a smart television, a smart display, a real-time multiplayer gaming console, or the like. In various additional embodiments, the process 900 may be executed on a cloud service accessed by the computing device. In many embodiments, the process 900 may receive an event, where the event is one of a plurality of events associated with an application (block 910). In a variety of embodiments, the application may be a latency-sensitive real-time application that is run or executed by the computing device. In a number of embodiments, the plurality of events may include two or more of a network event, an operating system event, a timer event, a communication event, a collaboration event, a security event, or a user input event. Examples of the latency-sensitive real-time application may include collaboration applications, cloud-based interactive applications, multi-player real-time gaming applications, or the like, whose performance can degrade if latency exceeds configured threshold limits.

In additional embodiments, the process 900 may predict, from a plurality of actions, an action for the received event, the action including one of running the received event on a low-power thread or running the received event on a standard-power thread (block 920). In an example, the process 900 may predict the action as a random decision. In further examples, the process 900 may predict the action based on a reward associated with a historical action for the same event.

In more embodiments, the process 900 may perform the action for the received event (block 930). In an example, the process 900 may run the received event on the low-power thread. In further examples, the process 900 may run the received event on the standard-power thread.

In a number of embodiments, the process 900 may obtain one or more performance characteristics (block 940). In an example, the process 900 may obtained the performance characteristics associated with the computing device or the application. Performance characteristics may include application response time, processor utilization, memory access cycles, or the like during the execution of the received event. In yet more embodiments, the process 900 can obtain processor utilization value from various system performance monitoring sources such as operating system's task manager, performance counters, telemetry tools, or the like. Similarly, the process 900 can obtain a UI response time associated with the application from system monitoring and event-tracing mechanisms (such as watchdog timers), application layer which can track unresponsive UI states of the application, or the like.

In still yet more embodiments, the process 900 may determine a reward for the performed action for the received event (block 950). The process 900 may determine a reward for the performed action for the received event based on the performance characteristics. In an example, the action of running the received event on the low-power thread may result in reduction of the processor utilization value while maintaining the UI response time below a maximum allowed response time threshold limit. In this scenario, the reward may indicate that the action has beneficially impacted the performance characteristics. Likewise, if running the received event on the low-power thread reduces the processor utilization value but increases the UI response time beyond the maximum allowed response time threshold limit, the reward may indicate that the action has adversely impacted the performance characteristics. In several embodiments, the reward may be a numerical value that is a function of the performance characteristics. In further embodiments, the reward may be inversely related to the utilization value of the processor and the UI response time associated with the application. The reward may reflect the effectiveness of the performed action in achieving energy efficiency while maintaining application performance.

In numerous embodiments, the process 900 may stores the received event, the performed action, and the determined reward in a decision database (block 960). In further embodiments, the decision database may be stored in the memory of the computing device. In further additional embodiments, the decision database may correspond to a tabular database with each row indicating a reward of a particular action for a particular received event.

In several embodiments, the process 900 may determine whether the reinforcement learning process is complete (block 965). In several more embodiments, the process 900 may determine that the reinforcement learning process (e.g., learning phase) is complete in response to stabilization in reward values in the decision database. For example, if the performed action yielded substantially the same reward value as reward values of a configured count of most recent instances of the same event-action pair, the process 900 may determine that the reinforcement learning process is complete. However, if the reward of the performed action varies from at least one reward value of a previous instance of the same event-action pair, within the configured count of most recent instances of the same event-action pair, by more than a threshold value (e.g., convergence limit), the process 900 may determine that the reinforcement learning process is not complete. If the reinforcement learning process is incomplete, the process 900 may continue to iteratively learn more reward values (block 910).

In many further embodiments, the process 900 may learn an event scheduling ruleset for the application that defines whether to run an event of the plurality of events on the low-power thread or the standard-power thread (block 970). The learning of the event scheduling ruleset may be based on the decision database. In many examples, the event scheduling ruleset may indicate a thread scheduling choice (one of the low-power thread or the standard-power thread) for each event of the plurality of events. In many further examples, the event scheduling ruleset may indicate a thread scheduling preference (one of the low-power thread or the standard-power thread) for each event of the plurality of events.

Although a specific embodiment for a process 900 for implementing reinforcement learning-based event scheduling and optimizing energy consumption suitable for carrying out the various steps, processes, methods, and operations described herein is discussed with respect to FIG. 9, any of a variety of systems and/or processes may be utilized in accordance with embodiments of the disclosure. For example, the process 900 operates iteratively, enabling the computing device to learn adapting to real-time workloads and dynamically adjusting event scheduling. By leveraging reinforcement learning, the process 900 may continually improve energy efficiency and maintain application performance. The elements depicted in FIG. 9 may also be interchangeable with other elements of FIGS. 1-8 and 10-11 as required to realize a particularly desired embodiment.

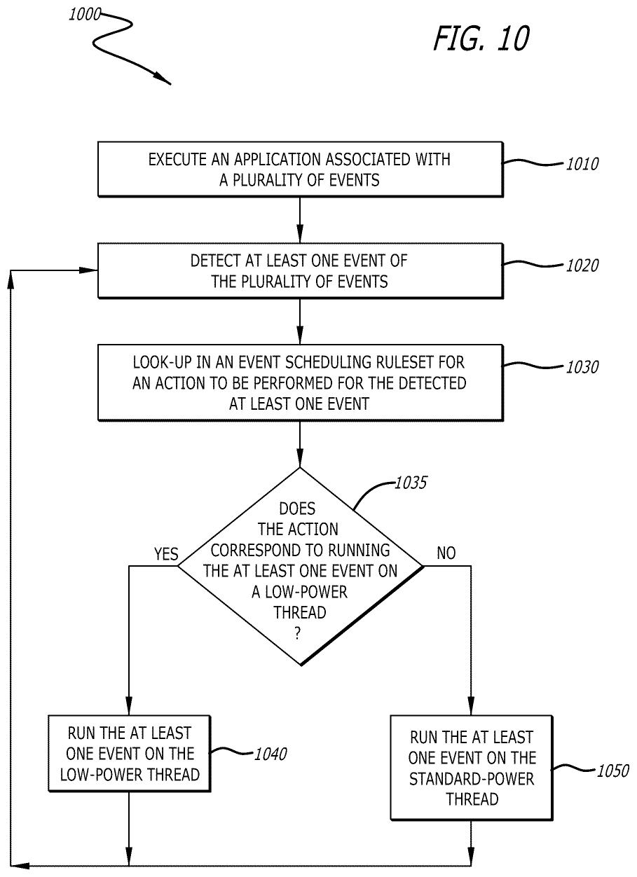

Referring to FIG. 10, a flowchart depicting a process 1000 for implementing event execution using a learned event scheduling ruleset in accordance with various embodiments of the disclosure is shown. In many embodiments, the process 1000 may execute an application associated with a plurality of events (block 1010). In various embodiments, the process 900 may be implemented on a computing device such as a desktop, a laptop, a computer, a smartphone, a tablet, a wearable device, a smart television, a smart display, a real-time multiplayer gaming console, or the like. In a number of embodiments, the application may be a latency-sensitive real-time application that is run or executed by the computing device. In various embodiments, the plurality of events may include two or more of a network event, an operating system event, a timer event, a communication event, a collaboration event, a security event, or a user input event. Examples of the latency-sensitive real-time application may include collaboration applications, cloud-based interactive applications, multi-player real-time gaming applications, or the like, whose performance can degrade if latency exceeds configured threshold limits.

In additional embodiments, the process 1000 may detect at least one event of the plurality of events (block 1020). In more embodiments, the detected event may be a real time event associated with the application. The detected event can be any of a network event, an operating system event, a timer event, a communication event, a collaboration event, a security event, or a user input event.

In a number of embodiments, the process 1000 may look up an event scheduling ruleset for an action to be performed for the detected event (block 1030). The event scheduling ruleset may be based on a reinforcement learning process that is iteratively performed over a time period for the application. In yet various embodiments, the event scheduling ruleset may define whether to run an event of the plurality of events on the low-power thread or the standard-power thread. Thus, by looking up the event scheduling ruleset, the process 1000 may select an action for the detected event.

In still more embodiments, the process 1000 may determine whether the action corresponds to running the at least one event on a low-power thread (block 1035). In some more embodiments, if the action corresponds to running the event on the low-power thread, the process 1000 may run the at least one event on the low-power thread (block 1040). However, in certain embodiments, if the action does not correspond to running the event on the low-power thread, the process 1000 may run the at least one event on the standard-power thread (block 1050).

Although a specific embodiment for a process 1000 for implementing event execution using a learned event scheduling ruleset suitable for carrying out the various steps, processes, methods, and operations described herein is discussed with respect to FIG. 10, any of a variety of systems and/or processes may be utilized in accordance with embodiments of the disclosure. For example, the process 1000 update the event scheduling ruleset after a configured time period or based on an update trigger by again performing a iterative machine learning process. By dynamically selecting the appropriate thread for event execution, the process adapts to real time conditions while maintaining system efficiency. The elements depicted in FIG. 10 may also be interchangeable with other elements of FIGS. 1-9 and 11 as required to realize a particularly desired embodiment.

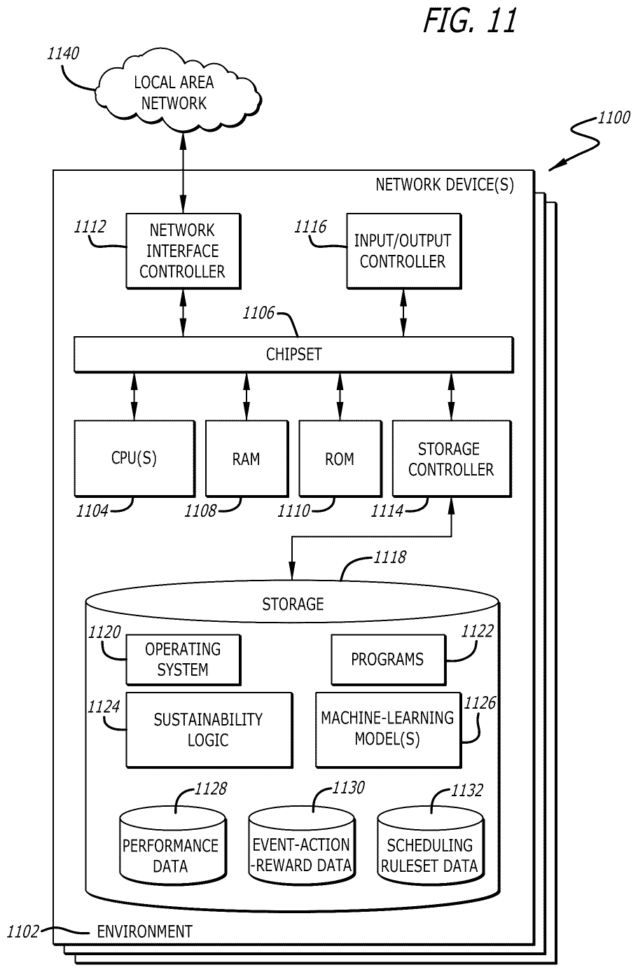

Referring to FIG. 11, a conceptual block diagram of a device 1100 suitable for configuration with a sustainability logic 1124 for implementing the functionality and various embodiments of the disclosure is shown. The embodiment of the conceptual block diagram depicted in FIG. 11 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 1100 may, in some examples, correspond to a physical device or to a virtual resource described herein. The device 1100 can be a computing device, for example, a desktop, a laptop, a computer, a smartphone, a tablet, a wearable device, a smart television, a smart display, a real-time multiplayer gaming console, or any other user equipment or electronic device capable of executing latency-sensitive real-time applications in accordance with various embodiments of the disclosure.

In many embodiments, the device 1100 may include an environment 1102 such as a baseboard or a “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In a number of embodiments, one or more processors 1104, such as, but not limited to, central processing units (CPUs) can be configured to operate in conjunction with a chipset 1106. The processor(s) 1104 can be standard programmable CPUs that perform arithmetic and logical operations necessary for the operation of the device 1100.

In a variety of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a Random-Access Memory (RAM) 1108, which can be utilized as the main memory in the device 1100 in some embodiments. The chipset 1106 can further be configured to provide an interface to a computer-readable storage medium such as a Read-Only Memory (ROM) 1110 or a Non-Volatile RAM (NVRAM) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Different embodiments of the device 1100 can be configured to operate in a networked environment using logical connections to remote computing devices and computer systems through a network, such as the network 1140. The chipset 1106 can include functionality for providing network connectivity through a Network Interface Controller (NIC) 1112, which may include a gigabit Ethernet adapter or similar component. The NIC 1112 can be capable of connecting the device 1100 to other devices over the network 1140. It is contemplated that multiple NICs 1112 may be present in the device 1100, connecting the device 1100 to other types of networks and remote systems.

In more embodiments, the device 1100 can be connected to a storage 1118 that provides non-volatile storage for data accessible by the device 1100. The storage 1118 can, for example, store an operating system 1120, programs 1122 (e.g., applications), performance data 1128, event-action-reward data 1130, and scheduling ruleset data 1132, which are described in greater detail below. The storage 1118 can be connected to the environment 1102 through a storage controller 1114 connected to the chipset 1106. In additional embodiments, the storage 1118 can include one or more physical storage units. The storage controller 1114 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology utilized to implement the physical storage units, whether the storage 1118 is characterized as primary or secondary storage, and the like. For example, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to the device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1118 can store an operating system 1120 utilized to control the operation of the device 1100. According to one embodiment, the operating system 1120 includes the LINUX operating system. According to another embodiment, the operating system 1120 includes the Windows® server operating system from Microsoft Corporation of Redmond, Washington. According to further embodiments, the operating system 1120 can include the UNIX operating system or one of its variants. It should be appreciated that other operating systems can also be utilized. The storage 1118 can store other system or application programs and data utilized by the device 1100.

In still more embodiments, the storage 1118 or other computer-readable storage media is encoded with computer-executable instructions which, when loaded into the device 1100, may transform the device 1100 from a general-purpose computing system into a special-purpose computer capable of implementing the embodiments described herein. These computer-executable instructions may be stored as programs 1122 (e.g., applications such as latency-sensitive real-time applications) and transform the device 1100 by specifying how the processor(s) 1104 can transition between states, as described above. In still further embodiments, the device 1100 has access to computer-readable storage media storing computer-executable instructions which, when executed by the device 1100, perform the various processes described above with regard to FIGS. 1-10. In still additional embodiments, the device 1100 can also include computer-readable storage media having instructions stored thereupon for performing any of the other computer-implemented operations described herein.

In some more embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 may not include all of the components shown in FIG. 11, and can include other components that are not explicitly shown in FIG. 11, or may utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

In yet various embodiments, the device 1100 can include a sustainability logic 1124 that may be responsible for executing one or more sustainability related operations with regards to the device 1100. The sustainability logic 1124 may be configured to provide a framework that incorporates a learning-based decision-making mechanism to dynamically allocate resources for executing events related to the program(s) 1122, optimizing energy consumption while maintaining application performance. The sustainability logic 1124 may be configured to iteratively perform a reinforcement learning process over a time period for an application such as a latency-sensitive real-time application. The latency-sensitive real-time application may be associated with a plurality of events. The sustainability logic 1124 may be further configured to learn, based on the iteratively performed reinforcement learning process, an event scheduling ruleset for the application that defines whether to run an event of the plurality of events on a low-power thread or a standard-power thread. The reinforcement learning process may include receiving an event associated with the application and performing an action based on the received event. The action may include one of running the received event on the low-power thread or running the received event on the standard-power thread. The reinforcement learning process may further include obtaining, upon performing the action, one or more performance characteristics associated with at least one of the processor(s) 1104 or the application, determining, based on the performance characteristics, a reward of the performed action for the received event, and storing the received event, the performed action, and the determined reward in a decision database, for example, the event-action-reward data 1130. The sustainability logic 1124 may be further configured to detect at least one event of the plurality of events, schedule the detected event based on the learned event scheduling ruleset, and run the detected event on one of a low-power thread or a standard-power thread based the scheduling.

Those skilled in the art will recognize that the sustainability logic 1124 can include various hardware and/or software deployments and can be configured in a variety of ways. In many additional embodiments, the sustainability logic 1124 can be configured as a standalone device, exist as a logic in another computing device, be distributed among various computing devices operating in tandem, or remotely operated as part of a cloud-based network management tool. In still yet further embodiments, one or more servers can be configured with the sustainability logic 1124 or can otherwise operate as the sustainability logic 1124. In still yet additional embodiments, the sustainability logic 1124 may operate on one or more servers connected to a communication network, for example, the Internet. The communication network can include wired networks or wireless networks. The sustainability logic 1124 can be provided as a cloud-based service that can service remote computing devices. Further, in several embodiments, the sustainability logic 1124 may be operated as a distributed logic across multiple computing devices.

In several more embodiments, the storage 1118 can include performance data 1128. The performance data 1128 may relate to performance characteristics associated with the processor(s) 1104, the application, the storage 1118, or the like observed or obtained based on executing a received event of the application. Performance characteristics may include application response time, processor utilization, memory access cycles, or the like during the execution of the received event. In yet more embodiments, the performance characteristics can be obtained from various system performance monitoring sources such as operating system's task manager, performance counters, telemetry tools, monitoring and event-tracing mechanisms (such as watchdog timers), application layer of the device 1100, or the like after or during the received is executed. Analyzing the performance characteristics provides an indication on whether there is need to execute the event on a different thread or not.

In numerous additional embodiments, the storage 1118 can include event-action-reward data 1130. The event-action-reward data 1130 may relate to the decision database in which the reward data regarding various actions performed for the plurality of events is accumulated during a training phase of the machine-learning based framework implemented by the sustainability logic 1124. In an example, the event-action-reward data 1130 may include a tabular database with each row indicating a reward of a particular action for a particular received event. Thus, the event-action-reward data 1130 at the training phase can have multiple rows for the plurality of events and corresponding reward values of performed actions.

In many embodiments, the storage 1118 can include scheduling ruleset data 1132. The scheduling ruleset data 1132 may include the event scheduling ruleset utilized by the sustainability logic 1124 for scheduling the plurality of events of the application, with an objective to reduce carbon footprint of the device 1100. The learning of the scheduling ruleset data 1132 may be based on the event-action-reward data 1130.

In a variety of embodiments, data may be processed into a format usable by a machine learning (“ML”) model 1126 (e.g., feature vectors), and/or other pre-processing techniques. The ML model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models. The ML model 1126 may be configured to analyze the performance data 1128, the event-action-reward data 1130, and the scheduling ruleset data 1132 for adaptively scheduling the plurality of events associated with the application and reducing the carbon footprint of the device 1100. In various embodiments, the ML model 1126 may be utilized to identify various parameters that can directly or indirectly indicate an environmental impact of running the application on the device 1100.

Although a specific embodiment for a device 1100 suitable for configuration with the sustainability logic 1124 for carrying out the various steps, processes, methods, and operations described herein is discussed with respect to FIG. 11, any of a variety of systems and/or processes may be utilized in accordance with embodiments of the disclosure. For example, the device may be implemented in a virtual environment such as a cloud-based network administration suite or a cloud computing environment, or the device may be distributed across a variety of electronic devices such that each acts as a device and the sustainability logic 1124 acts in tandem between the devices. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor; and
a memory communicatively coupled to the processor, wherein the memory comprises a sustainability logic that is configured to:
iteratively perform a reinforcement learning process over a time period for an application, wherein the application is associated with a plurality of events;
learn, based on the iteratively performed reinforcement learning process, an event scheduling ruleset for the application that defines whether to run an event of the plurality of events on a low-power thread or a standard-power thread; and
schedule at least one event of the plurality of events based on the learned event scheduling ruleset.

2. The device of claim 1, wherein the reinforcement learning process comprises:
receiving an event associated with the application, wherein the event is one of the plurality of events and the application corresponds to a latency-sensitive real-time collaboration application;
performing an action based on the received event, the action comprising one of running the received event on the low-power thread or running the received event on the standard-power thread;
obtaining, upon performing the action, one or more performance characteristics associated with at least one of the processor or the application;
determining, based on the one or more performance characteristics, a reward of the performed action for the received event; and
storing the received event, the performed action, and the determined reward in a decision database.

3. The device of claim 2, wherein the learning of the event scheduling ruleset is further based on the decision database.

4. The device of claim 3, wherein based on the decision database specifying that running a first event of the plurality of events on the low-power thread has a higher reward than running the first event on the standard-power thread, a first rule in the event scheduling ruleset for the first event defines a higher preference to run the first event on the low-power thread compared to running the first event on the standard-power thread.

5. The device of claim 4, wherein based on the decision database specifying that running a second event of the plurality of events on the low-power thread has a lower reward than running the second event on the standard-power thread, a second rule in the event scheduling ruleset for the second event defines a higher preference to run the second event on the standard-power thread compared to running the second event on the low-power thread.

6. The device of claim 3, wherein based on the decision database specifying that running a first event of the plurality of events on the low-power thread has a higher reward than running the first event on the standard-power thread, a first rule in the event scheduling ruleset for the first event defines the first event to be run on the low-power thread.

7. The device of claim 6, wherein based on the decision database specifying that running a second event of the plurality of events on the low-power thread has a lower reward than running the second event on the standard-power thread, a second rule in the event scheduling ruleset for the second event defines the second event to be run on the standard-power thread.

8. The device of claim 2, wherein the one or more performance characteristics comprise a utilization value of the processor and a user interface (UI) response time associated with the application.

9. The device of claim 8, wherein the reward is inversely related to the utilization value of the processor and the UI response time associated with the application.

10. The device of claim 2, wherein the sustainability logic is further configured to detect the at least one event after the learning of the event scheduling ruleset, and wherein upon the detection of the at least one event, the at least one event is scheduled to run on one of the low-power thread or the standard-power thread based on the event scheduling ruleset.

11. The device of claim 10, wherein the at least one event is scheduled to run on the standard-power thread based on a rule in the event scheduling ruleset defining a higher preference for the standard-power thread than the low-power thread for the at least one event.

12. The device of claim 10, wherein the at least one event is scheduled to run on the low-power thread based on a rule in the event scheduling ruleset defining a higher preference for the low-power thread than the standard-power thread for the at least one event.

13. The device of claim 1, wherein the sustainability logic is further configured to run the at least one event on one of the low-power thread or the standard-power thread based on the scheduling.

14. The device of claim 1, wherein the low-power thread corresponds to a low priority, throttled thread that has lower energy consumption compared to the standard-power thread.

15. The device of claim 1, wherein
the device corresponds to a computing device that runs the application, and
the plurality of events comprises two or more of: a network event, an operating system event, a timer event, a communication event, a collaboration event, a security event, or a user input event.

16. The device of claim 1, wherein the reinforcement learning process corresponds to a model-free reinforcement learning process.

17. A device, comprising:
a processor configured to execute an application associated with a plurality of events; and
a memory communicatively coupled to the processor, wherein the memory comprises a sustainability logic that is configured to:
detect at least one event of the plurality of events; and
run the at least one event on one of a low-power thread or a standard-power thread based on an event scheduling ruleset, wherein:
the event scheduling ruleset is based on a reinforcement learning process that is iteratively performed over a time period for the application, and
the event scheduling ruleset defines whether to run an event of the plurality of events on the low-power thread or the standard-power thread.

18. A method, comprising:
at a computing device that runs an application associated with a plurality of events:
iteratively performing a reinforcement learning process over a time period for the application;
learning, based on the iteratively performed reinforcement learning process, an event scheduling ruleset for the application that defines whether to run an event of the plurality of events on a low-power thread or a standard-power thread; and
scheduling at least one event of the plurality of events based on the learned event scheduling ruleset.

19. The method of claim 18, further comprises running the at least one event on one of the low-power thread or the standard-power thread based on the scheduling.

20. The method of claim 18, wherein
the reinforcement learning process comprises:
receiving an event associated with the application, wherein the event is one of the plurality of events;
performing an action based on the received event, the action comprising one of running the received event on the low-power thread or running the received event on the standard-power thread;
obtaining, upon performing the action, one or more performance characteristics associated with the computing device or the application;
determining, based on the one or more performance characteristics, a reward of the performed action for the received event; and
storing the received event, the performed action, and the determined reward in a decision database, wherein the learning of the event scheduling ruleset is further based on the stored decision database.
